(19) United States
(12) Patent Application Publication
(10) Pub. No.: US 2003/0004948 A1
(43) Pub. Date: Jan. 2, 2003

(54) System and method for retrieving data from disk in a network environment

(75) Inventors: Patrick Joseph Bohrer, Austin, TX (US); Bishop Chapman Brock, Coupland, TX (US); Elmootazbellah Nabil Elnozahy, Austin, TX (US); Ramakrishnan Rajamony, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation

(21) Appl. No.: 09/895,234

(22) Filed: Jun. 29, 2001

(51) Int. Cl. G06F 7/00

(52) U.S. Cl. 707/10

(57) ABSTRACT

A system and method of retrieving data from a disk includes determining the network transfer rate of a network connection between a client and a server. A first portion of the requested data is retrieved from the disk responsive to a data request received by the server from the client via a network connection and transmission of the first portion of data to the client via the network is initiated. The time required to transmit the first portion of data to the client is calculated based upon the network transfer rate and a determination of when to retrieve a subsequent portion of the requested data from disk is made based, in part, on whether the calculated time is expired. The determination of when to retrieve subsequent portions of data from disk may be further based on a desire to minimize a system parameter such as memory usage or disk energy consumption and heat dissipation.

### BACKGROUND

1. Field of the Present Invention

The present invention generally relates to the field of data processing networks and more particularly to a system and method for improving the performance of networked systems by considering the network transfer rate as a parameter in determining how to retrieve data from a disk.

2. History of Related Art

In the field of data processing networks, servers are widely used to provide distributed access to applications and data from clients that are connected to the network. In a web server, data is typically fetched from the disk and sent back to the client using a Transmission Control Protocol (TCP) connection. In such an environment, the data transfer rate over the network between the server and the client (referred to herein as the network transfer rate) is a function of the connection bandwidth. The connection bandwidth is typically variable and depends on the properties of the link between the client and the server. Thus, the server may simultaneously have a high data-transfer rate to a first client and a slow data transfer rate to a second client.

Typically, when a client request for data is received by a web server, the server software starts to fetch all of the blocks that comprise the requested file or data. Fetching the requested data in its entirety may have undesirable consequences. Since the data is fetched from disk at a data rate (the disk transfer rate) that may be significantly higher than the network transfer rate, much of the fetched data will have to be buffered or stored in scarce server memory until the server can transmit the data over the network.

In addition, the requested data is rarely stored on in contiguous physical positions on the disk or disks. Accessing data from a disk in physically discontinuous locations requires physical movement of the disk head, which is slow, consumes a lot of energy and dissipates a lot of heat, all of which are undesirable. The energy consumed and heat dissipated by the movement of disk heads is increasingly becoming a critical factor in the design of data centers.

Therefore it would desirable to implement a system and method for accessing data from disk in response to a network request in which the network transfer rate is factored into by the disk scheduling mechanism to optimize the data retrieval over a desired parameter such as throughput, memory consumption, or energy consumption.

### SUMMARY OF THE INVENTION

The problems identified are addressed in large part by a system and method of retrieving data from a disk that includes determining the network transfer rate of a network connection between a client and a server. A first portion of the requested data is retrieved from the disk responsive to a data request received by the server from the client via a network connection and transmission of the first portion of data to the client via the network is initiated. The time required to transmit the first portion of data to the client is calculated based upon the network transfer rate and a determination of when to retrieve a subsequent portion of the requested data from disk is made based, in part, on whether the calculated time is expired. The determination of when to retrieve subsequent portions of data from disk may be further based on a desire to minimize a system parameter such as memory usage or disk energy consumption and heat dissipation.

### BRIEF DESCRIPTION OF THE DRAWINGS

Other objects and advantages of the invention will become apparent upon reading the following detailed description and upon reference to the accompanying drawings in which:

FIG. 1 is a block diagram of a data processing network;

FIG. 2 is a block diagram of selected features of the network of FIG. 1;

FIG. 3 is an illustration of portions the disk of FIG. 1;

FIG. 4 is a flow diagram illustrating a method of retrieving data from disk according to an embodiment of the invention; and

FIG. 5 is a flow diagram illustrating a method of retrieving data from disk according to an embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

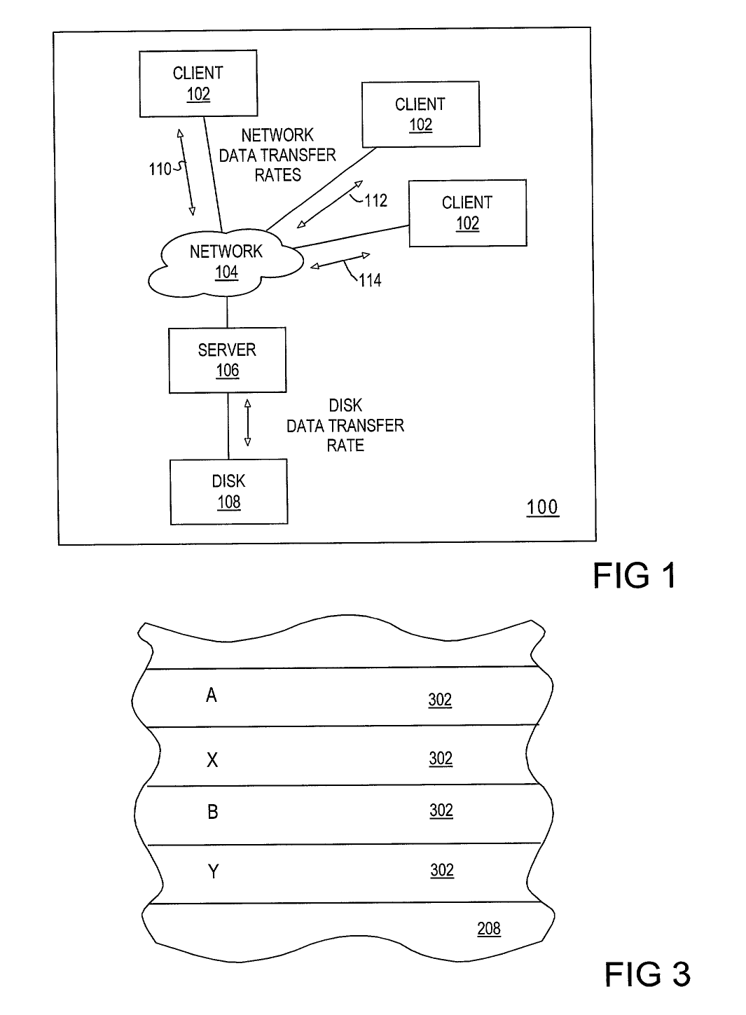

Turning now to the drawings, FIG. 1 illustrates selected components of a data processing system 100 according to one embodiment of the present invention. In the depicted embodiment, network 100 includes one or more clients 102 that are configured to transmit data requests to a server 106 over a network 104 to which each of the devices is connected. Network 104 may comprise a local area network (LAN) implemented using Ethernet or another suitable network technology. In another embodiment, network 104 may represent a wide area network or the Internet and may include a variety of network routers, hubs, gateways, and intermediate servers.

Network 104 and each of the attached clients 102 and server 106 typically support the Transmission Control Protocol/Internet Protocol (TCP/IP) suite of protocols. TCP/IP provides the foundation and framework for many computer networks including the Internet. TCP/IP is extensively documented in a variety of publications including M. Murhammer et al., TCP/IP Tutorial and Technical Overview, available online at www.redbooks.ibm.com (#GG24-3376-05) and incorporated by reference herein. In a TCP/IP environment, each client 102 may communicate with server 106 via a dedicated TCP connection. The various TCP connections between client 102 and server 106 are indicated in FIG. 1 by reference numerals 110, 112, and 114. Each TCP connection may have a characteristic data transfer rate or network transfer rate that is indicative of the rate at which data is exchanged between the corresponding client 102 and server 106. The data transfer rate of each TCP connection depends on the properties of the connection. Typically, web sever 106 knows or can derive the network transfer rate of each of its TCP connections based upon data transfer statistics.

Network 100 as depicted in FIG. 1 further includes data storage device(s) indicated by reference numeral 108. Storage 108 is connected to and accessible from server 106. In one embodiment, storage 108 may be an integrated component of server 106. In other embodiments, storage 108 may be implemented as a storage area network (SAN). A SAN is a high speed network, comparable to a Local Area Network (LAN), comprised of interconnected storage devices such as disk drives that allows the establishment of direct connections between storage devices and servers. A SAN can be shared between multiple servers 106 or dedicated to one server. For additional information regarding SANs, the interested reader is referred to Ravi K. Khattar et al., Introduction to Storage Area Network, SAN (IBM 1999), which is accessible from the URL http://www.redbooks.ibm.com/redbooks/SG245470.html and incorporated by reference herein.

Generally speaking, the invention contemplates optimizing the retrieval of data from storage 108. More specifically, the invention includes a system and method in which the network transfer rate(s) of one or more client/server connections is used as a control parameter in retrieving data from storage 108 in response to a request from a client 102. The network transfer rate may be used to optimize data retrieval over various parameters including memory usage, data retrieval performance, and storage device energy consumption and heat dissipation. Regardless of the parameter or parameters that are optimized, using the network transfer rate as a control parameter in retrieving data from disk reflects that increasingly prevalent reality of client/sever networks. Moreover, the present invention recognizes the central importance of disk storage devices in the modern network scheme in which data presentation is primarily the task of the desktop or network computer (i.e., clients 102), data processing is primarily allocated to the application server 106, and data storage is allocated to storage 108.

Portions of the present invention may be implemented as a sequence of instructions (i.e., computer software) executable by a microprocessor or other suitable computing device. The instructions are typically stored in or on a computer program product or computer readable medium such as a system memory, ROM, flash memory, hard disk, floppy diskette, CD ROM, DVD, or magnetic tape.

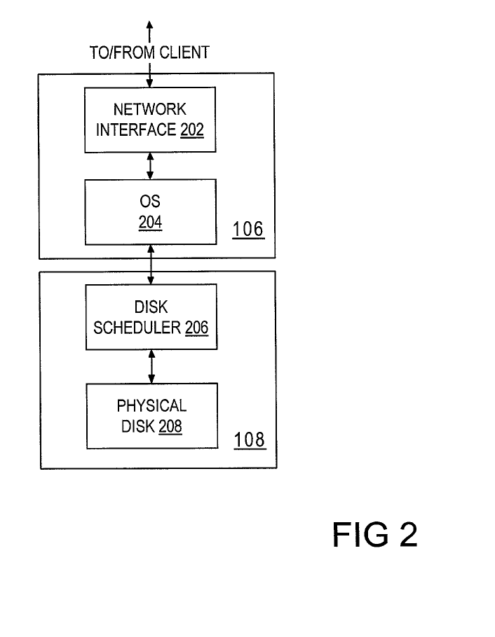

Referring now to FIG. 2, a block diagram of selected portions of server 106 and storage 108 is presented to emphasize features of the present invention. In the depicted embodiment, server 106 and storage 108 include a network interface 202, an operating system 204, a disk scheduler 206, and at least one physical disk 208.

Network interface 202 enables operating system 204 to receive packets of information from and send packets to clients 102 via network 104. Typically, a client requests are delivered over network 104 as one or more information packets, each packet with its own set of protocol specific packet headers. The packet headers may include information regarding the source and destination of the corresponding packet, the validity of the packet, and other implementation specific network information. In a TCP/IP network embodiment, for example, each packet includes a TCP header that is used to verify the integrity of the packet and an IP header that indicates the packets network destination address.

In one embodiment, network interface 202 comprises hardware commonly referred to as a network interface card (NIC). In this embodiment, the NIC is typically responsible for capturing packets addressed to server 106, processing a level header such as the Media Access Control (MAC) header in an Ethernet implementation, and providing the remainder of each packet to operating system 204. In other embodiments, the NIC may include dedicated hardware for processing additional levels of the network protocol headers.

Operating system 204 provides an environment in which applications on server 106 can execute and communicate with other devices over the network. Operating system 204 may be a Unix-based operating system such as the AIX® operating system from IBM although the invention is not intended to be limited to Unix operating systems. In one embodiment, operating system 204 includes facilities or code enabling communication over a TCP/IP compliant network.

If a request issued by client 102 is a request for data residing on storage 108, operating system 204 and disk scheduler 206 work in conjunction to retrieve the requested data from storage 108. In a conventional server/storage arrangement, the operating system is unaware of the manner in which data is stored on physical disk 208. Typically, data files of any significant size are not stored in physically contiguous storage locations of physical disk 208. Instead, portions of a data file may be distributed over various tracks of physical disk 208. The disk scheduler is responsible for determining the physical location(s) of data on the physical disk and for ordering or scheduling the retrieval of the data. If the data is located on multiple tracks, the disk scheduler is responsible for moving the recording head to the appropriate tracks in the appropriate order.

In a conventional server/storage configuration, the operating system typically treats each file request as a single request to retrieve the entire file immediately. The operating system may convert the file request into a set of request for logical blocks and pass the set of logical blocks to disk scheduler, which is responsible for mapping the requested logical blocks to physical blocks on the disk. Neither the operating system nor the disk scheduler is typically configured to consider the network transfer rate of the link between the requesting client and the server when retrieving the requested data from disk. Thus, in a conventionally designed network, a client request for data is handled substantially identically whether the request is received over a slow connection or a fast connection.

Operating system 204 and disk scheduler 206 according to the present invention, however, are configured to retrieve data from disk in response to a client request based, at least in part, on the network transfer rate of the network connection between the server and the client. By configuring operating system 204 and disk scheduler 206 to account for the network transfer rate, which is typically significantly lower than the disk transfer rate, the retrieval of information from disk can be better optimized over various parameters including memory usage, power consumption, and performance.

Referring now to FIG. 3, a conceptualized depiction of a portion of physical disk 208 is presented to illustrate an example of optimized data retrieval according to the present invention. In the depicted illustration, physical disk 208 includes various tracks 302, each identified by a unique letter. The track 302 “A” is physically adjacent to track 302 “X,” which is adjacent track 302 “B,” and so forth. Consider a scenario in which a client 102 requests a file from server 106 and the blocks comprising requested file are stored on storage 108 and, more specifically, on track 302 “A” and track 302 “B” of physical disk 208. In a conventional server/storage environment, the operating system would treat the file request as a single request for all of the blocks that comprise the file and pass the request on to the disk scheduler a request for a set of logical blocks. To satisfy this request, the disk scheduler would convert or map the requested logical blocks to physical block locations. The disk scheduler would then physically move the recording heading to block “A”, retrieve the information from block “A”, move the head to block “B”, and then retrieve the information from block “B”. This method of retrieving data in response to a client request in a web-based environment is more than likely inefficient because the rate at which data is retrieved from storage 108 to server 106 is almost certainly greater than the rate at which the data can be transmitted to client 102. Therefore, an opportunity exists during the retrieval of data from storage 108 to improve the usage of one or more system resources. More specifically, under the assumption that server 106 and storage 108 are able to determine the network transfer rate of each connection between server 106 and client(s) 102, the system could use this network transfer rate information to improve the data retrieval process by, for example, conserving system memory in server 106, minimizing the energy consumed and heat dissipated by the physical disk, or optimizing for performance (speed) of retrieval.

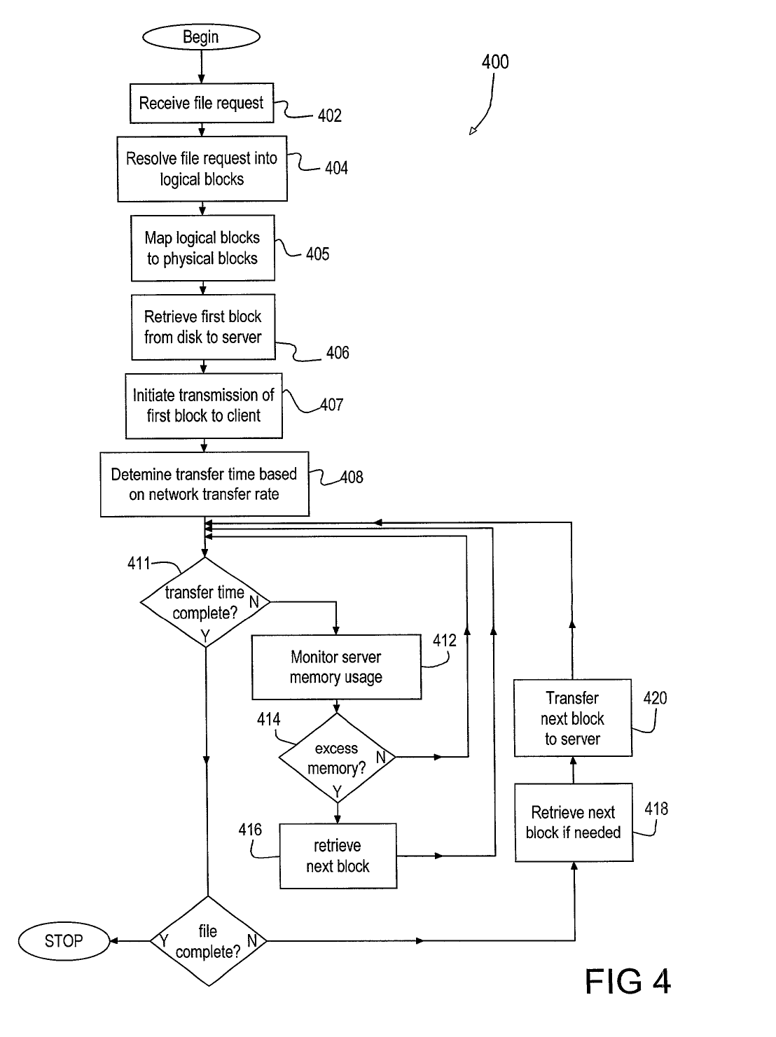

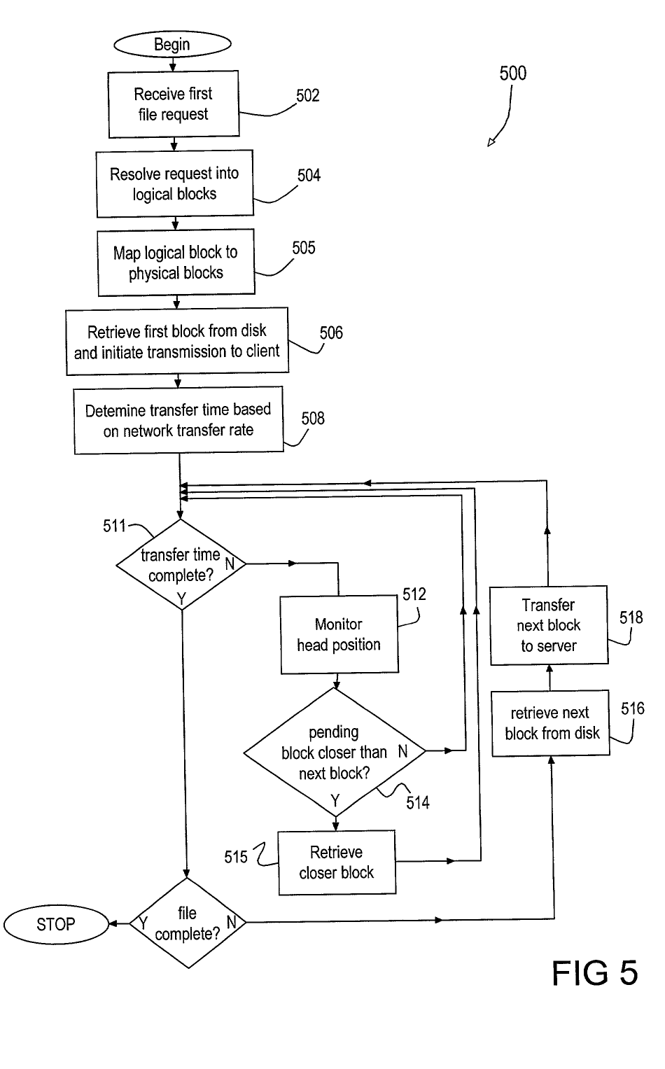

FIG. 4 illustrates a method 400 by which a client request for data in a network environment is processed according to an embodiment of the invention in which it is desirable to optimize server memory allocation. In this embodiment, it is presumed that server 106 may be handling a variety of requests and tasks and that server 106 may be memory constrained. In the depicted embodiment, client 102 sends a request for data to server 106. The request for data may by be transmitted between client 102 and server 106 as a set of frames or packets over a TCP connection. The data request is received (block 402) by server 106. The data request may consist of or include a request for a data file residing on storage 108. Moreover, portions of the requested file may reside on two or more physical tracks 302 of disk 208. In accordance with the present invention, operating system 204 resolves (block 404) the file request into a set of requests for the logical blocks corresponding to the requested file and passes the logical block requests to disk scheduler 206. Disk scheduler 206 then maps or converts (block 405) the logical block requests into a set of requests for the physical blocks 302 of storage 108 that comprise the requested file.

Data from the first block 302 of disk 208 is then retrieved (block 406) and stored in the server memory. Transmission of the first block of data to client 102 over network 104 is then initiated (block 407). In addition, the network transfer time is determined (block 408) based on the network transfer rate of the appropriate client/server connection. In an embodiment of the invention emphasizing server memory allocation, it is desirable to retrieve data from disk 208 before it is absolutely needed by server 106 only if there is sufficient unused server system memory. Because data from second and subsequent blocks 302 of storage 208 will not be needed until the first block is transmitted to client 102 over network 104, the depicted embodiment of the invention is configured to delay the retrieval of data from subsequent blocks if server memory is unavailable. Thus, after retrieving the first block, server 106 enters a loop during the time the block is being transmitted over network 104 to client 102 (as determined in decision block 411). Within the loop, the server memory allocation is monitored (block 412). If the server detects excess memory capacity in block 414, the server may retrieve (block 416) the next block of data from storage 108. If the server detects that there is no excess memory, however, it will delay the retrieval of the second and subsequent data blocks until the data is absolutely needed (i.e., until the transfer time for the first or preceding block of data is expired and the block has been transmitted over network 104 to the requesting client 102). After the transfer time for the preceding block is complete, the next block of data is retrieved in block 418 (if it has not already been retrieved in block 416) and the transmission of the block over the network is initiated in block 420. In this manner, the depicted embodiment of the invention is able to optimize a system resource, namely, server memory, by using the network transfer rate to determine when data is needed and retrieving data from disk before it is needed only if the system is able to accommodate it.

In one embodiment, the server may include a predetermined and preferably programmable threshold value of available memory upon which the determination in block 414 is based. If the available server memory exceeds the predetermined value, then the retrieval of subsequent blocks of data from disk can be initiated. Otherwise, the system will postpone data retrieval from disk until required by the network.

Turning now to FIG. 5, a second embodiment of the invention is depicted in which the data retrieval process is structured to optimize (i.e., minimize) energy consumption and heat dissipation by disk 208. In this embodiment, the server and disk scheduler are configured to retrieve data from disk based, at least in part, upon the current position of the disk head. As will be familiar to those skilled in the field of hard disk design, the physical movement of the read/write head is responsible for a significant portion of the energy consumed and heat generated by the disk. Minimizing these parameters is becoming increasingly important for web-based applications in which there may be one or more machine stacks entirely populated with disks.

As depicted in FIG. 5, the initial blocks of file request handling process 500 are substantially analogous to the initial blocks of the file request handling process 400 depicted in FIG. 4. More specifically, process 500 includes the receipt (block 502) by server 106 of a file request from a client 102 via network 104. The file request is resolved (block 504) into its component logical blocks and mapped into the corresponding physical blocks (block 505). The data from the first physical block is then retrieved from disk and the transmission of the data to the client is initiated (block 506). The transfer time is determined (block 508) based upon the network transfer rate of the corresponding client/server connection.

The server then enters a loop during the pendency of the calculated transfer time (as determined in block 511) in which the read/write head position is monitored (block 512) with respect to the physical position of data blocks yet to be retrieved from disk to memory. If disk scheduler 206 determines that the physical location of a pending block is closer to the current position of the read/write head than the physical location of the next sequentially ordered block, the retrieval of data from the block that is closer may be prioritized over the retrieval of data from the next sequential block to minimize the physical movement of the read/write head. Thus, a decision is made in block 514 whether there is data on a track that is physically closer to the current head position than the track that would be next accessed if the request were processed sequentially. If there is data that is closer to the current head position and the system does not yet require the next sequentially ordered block of data (because the first block of data is still transmitting to the client), the server may retrieve (block 515) the data that is closer to its current head position before continuing to retrieve data sequentially. When the transfer time expires, the next sequential portion of data is retrieved (block 516) from disk and the transmission of the data over the network is initiated (block 518).

The concept of prioritizing data retrieval to minimize disk head movement and heat dissipation and conserve energy may be expanded to include scenarios in which two or more file requests are pending simultaneously. Referring back to FIG. 3, consider a first file request initiated at time T0 (in seconds) for a file that includes data on Track A and Track B. The network transfer rate is determined to be 1 track/10 seconds. The system will begin retrieving the data from track A. The second file request occurs at time T5 for data that is located on tracks X and Y. Because the data on track X is closer to the current position of the read/write head than the data on track B and because the server does not need the data from track B until T10, the system may prioritize the retrieval of data from track X over the retrieval of data from track B based on the current position of the read/write head and the network transfer rate. In this manner, the system produces reduced travel of the read/write head. More specifically, instead of traveling from track A to track B, back to track X, and then over to track Y. The system would move the head from track A to track B to track X to track Y thereby improving throughput and minimizing head movement, energy consumption, and heat dissipation without negatively affecting network performance.

While two examples have been presented to illustrate specific examples of the optimization of handling retrieval of data from disks in response to network file requests, the present invention is not limited to optimizing the illustrated parameters. More generally, the invention contemplates accounting for the relatively slow network transfer rate in determining when data is required to be retrieved from disk. The invention is intended include the optimization of any appropriate parameter based at least in part upon the network transfer rate. In addition, the invention may include the optimization of a group of two or more parameters simultaneously.

Thus, it will be apparent to those skilled in the art having the benefit of this disclosure that the present invention contemplates optimizing data retrieval from disk in response to a network file request based upon the network transfer rate. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of retrieving data from a disk, comprising:
determining the network transfer rate of a network connection between a client and a server;
responsive to a data request received by the server from the client via a network connection, retrieving a first portion of the requested data from the disk;
initiating transmission of the first portion of data to the client via the network;
calculating the time required to transmit the first portion of data to the client based upon the network transfer rate; and
retrieving a subsequent portion of the requested data from disk based, at least in part, on whether the calculated time is expired.

2. The method of claim 1, wherein determining the network transfer rate comprises determining the network transfer rate of a TCP connection between the client and the server.

3. The method of claim 1, wherein retrieving a first portion of the requested data comprises retrieving data from a first block of the disk.

4. The method of claim 1, wherein determining when to retrieve a subsequent portion of the requested data from disk includes delaying retrieval of the subsequent portion until the calculated time is expired to minimize the server system memory required to complete the file request.

5. The method of claim 1, wherein determining when to retrieve the subsequent portion of the requested data includes determining when to retrieve the subsequent portion based at least in part on the distance between the current head position and the disk location of the subsequent portion of data.

6. The method of claim 1, wherein determining when to retrieve a subsequent portion of the requested data from disk includes monitoring the position of the disk head while the first portion of data is being transmitted to the client.

7. The method of claim 6, further comprising determining the disk location of the subsequent portion of data associated with the first request and determining the disk location of a portion of data associated with a second file request.

8. The method of claim 7, further comprising retrieving the portion of data associated with the second file request if the data is closer to the current head position than the data associated with the subsequent portion of the first file request.

9. The method of claim 8, further comprising retrieving the subsequent portion of data associated with the first file request after the calculated time expires.

10. A computer program product comprising a computer readable medium containing computer executable instructions for retrieving data from disk comprising:
computer code means for determining the network transfer rate of a network connection between a client and a server;
computer code means for retrieving a first portion of the requested data from the disk responsive to a data request received by the server from the client via a network connection;
computer code means for initiating transmission of the first portion of data to the client via the network;
computer code means for calculating the time required to transmit the first portion of data to the client based upon the network transfer rate; and
computer code means for retrieving a subsequent portion of the requested data from disk based, at least in part, on whether the calculated time is expired.

11. The computer program product of claim 10, wherein the code means for determining the network transfer rate comprises code means for determining the network transfer rate of a TCP connection between the client and the server.

12. The computer program product of claim 10, wherein the code means for retrieving a first portion of the requested data comprises code means for retrieving data from a first block of the disk.

13. The computer program product of claim 10, wherein the code means for determining when to retrieve a subsequent portion of the requested data from disk includes code means for delaying retrieval of the subsequent portion until the calculated time is expired to minimize the server system memory required to complete the file request.

14. The computer program product of claim 10, wherein the code means for determining when to retrieve the subsequent portion of the requested data includes code means for determining when to retrieve the subsequent portion based at least in part on the distance between the current head position and the disk location of the subsequent portion of data.

15. The computer program product of claim 10, wherein the code means for determining when to retrieve a subsequent portion of the requested data from disk includes code means for monitoring the position of the disk head while the first portion of data is being transmitted to the client.

16. The computer program product of claim 15, further comprising computer code means for determining the disk location of the subsequent portion of data associated with the first request and computer code means for determining the disk location of a portion of data associated with a second file request.

17. The computer program product of claim 16, further comprising computer code means for retrieving the portion of data associated with the second file request if the data is closer to the current head position than the data associated with the subsequent portion of the first file request.

18. A data processing system, comprising:
at least one disk;
a server connected to a network and having access to the disk, wherein the server is further connected to a client via a TCP connection;
wherein the system includes:
computer code means for determining the network transfer rate of a network connection between a client and a server;
computer code means for retrieving a first portion of the requested data from the disk responsive to a data request received by the server from the client via a network connection;
computer code means for initiating transmission of the first portion of data to the client via the network;
computer code means for calculating the time required to transmit the first portion of data to the client based upon the network transfer rate; and
computer code means for determining when to retrieve a subsequent portion of the requested data from disk based, at least in part, on whether the calculated time is expired.

19. The system of claim 18, wherein the code means for retrieving a first portion of the requested data comprises code means for retrieving data from a first block of the disk.

20. The system of claim 18, wherein the code means for determining when to retrieve a subsequent portion of the requested data from disk includes code means for delaying retrieval of the subsequent portion until the calculated time is expired to minimize the server system memory required to complete the file request.

21. The system of claim 18, wherein the code means for determining when to retrieve the subsequent portion of the requested data includes code means for determining when to retrieve the subsequent portion based at least in part on the distance between the current head position and the disk location of the subsequent portion of data.

22. The system of claim 18, wherein the code means for determining when to retrieve a subsequent portion of the requested data from disk includes code means for monitoring the position of the disk head while the first portion of data is being transmitted to the client.

23. The system of claim 22, further comprising computer code means for determining the disk location of the subsequent portion of data associated with the first request and computer code means for determining the disk location of a portion of data associated with a second file request.

24. The system of claim 23, further comprising computer code means for retrieving the portion of data associated with the second file request if the data is closer to the current head position than the data associated with the subsequent portion of the first file request.
